(19) United States
(12) Patent Application Publication
(10) Pub. No.: US 2005/0225916 A1
(43) Pub. Date: Oct. 13, 2005

(54) Ultrasound membrane transducer collapse protection system and method

(75) Inventors: Mirsaid Bolorforosh, Portola Valley, CA (US); Stephen R. Barnes, Bellevue, WA (US); John D. Marshall, Campbell, CA (US)

Correspondence Address: Siemens Corporation;Intellectual Property Department, 170 Wood Avenue South, Iselin, NJ, 08830, US

(73) Assignee: Siemens Medical Solutions USA, Inc.

(21) Appl. No.: 10/817,552

(22) Filed: Apr. 2, 2004

(51) Int. Cl. H02H 9/04

(52) U.S. Cl. 361/91.1

(57) ABSTRACT

Damage to a capacitive membrane ultrasound transducer is prevented. High voltage protection circuitry is connected with the CMUT. The high voltage protection circuitry is integrated into the CMUT or is provided as external circuitry in the transducer or on the imaging systems. Providing high voltage protection circuitry with a CMUT avoids breakdown voltages associated with the CMUT. Since the high voltage protection circuitry is being used with a CMUT, the high voltage protection circuitry works with a preamplifier adjacent to the membranes for impedance purposes. In one embodiment, the high voltage protection circuitry connects between the membrane and the preamplifier, but may connect elsewhere along the transmit and receive path.

### BACKGROUND

The present invention relates to capacitive membrane ultrasound transducers (CMUT). In particular, damage to CMUT transducer is prevented.

CMUT transducers include one or more membranes and associated voids. As acoustic energy contacts the membrane, the membrane flexes. Using an electrode on the membrane and another in the void, a current is generated in response to flexing of the membrane. To generate acoustic energy, an electrical potential is applied to the electrodes, causing the membrane to flex. However, the flexing of the membrane may allow for the electrodes to become close enough to generate an electrical discharge or spark. Such electrical discharges may fuse the membrane in a bottomed-out position, cause damage to the electrodes or reduce performance of the membrane and associated transducer. High voltages are typically desired for generating acoustic energy. However, a breakdown more likely occurs for higher voltages. The transmitter is regulated to avoid generating excessive voltages. However, controlling the voltage generated may not be accurate or within acceptable tolerances. Additionally, patients or the sonographer in a medical environment may develop a static charge. When a transducer is positioned adjacent to a patient or when the transducer is handled by the sonographer, the static charge may cause a breakdown of the membrane. Other sources of breakdown may include charges generated during manufacturing, testing, calibration, shipping, handling, or moving the equipment around in the medical environment.

To avoid breakdown, the membrane may be manufactured with a greater thickness, reducing the likelihood of the electrodes being sufficiently close together for breakdown. Another approach is to put an insulation layer, bumps or other barriers within the void, such as at the bottom of the void or on the bottom of the membrane, to prevent the electrodes from becoming sufficiently close to cause an electrical breakdown. However, modifying the membrane structure may result in less desirable performance for transducing between acoustic and electric energies and increase costs.

Other types of transducers include piezoelectric based elements. A ceramic is used to transduce between acoustic and electrical energies. To avoid applying an overly large voltage adjacent to patients due to a flaw in circuitry, piezoelectric transducers include an over voltage protection circuit. The transmit and receive path associated with each element is connected to a high DC positive voltage and a high DC negative voltage through diodes. If the voltage on a transmit and receive line reaches the high positive or negative voltage, current is shunted to the voltage sources. As a result, the voltage on the transmit and receive line is limited to being between the high positive voltage and the high negative voltage.

### BRIEF SUMMARY

By way of introduction, the preferred embodiments described below include methods and systems for preventing damage to a capacitive membrane ultrasound transducer. High voltage protection circuitry is connected with the CMUT transducer. The high voltage protection circuitry is integrated into the CMUT or is provided as external circuitry in the transducer or in the imaging system. Providing high voltage protection circuitry with a CMUT avoids breakdown voltages associated with the CMUT. Since the high voltage protection circuitry is being used with a CMUT, the high voltage protection circuitry works with a preamplifier adjacent to the membranes for impedance purposes. In one embodiment, the high voltage protection circuitry connects between the membrane and the preamplifier, but may connect elsewhere along the transmit and receive path.

In one aspect, a system is provided for preventing damage to a CMUT. A conductor connects with a membrane. A voltage limiting circuit connects with the conductor.

In a second aspect, a method is provided for preventing damage to a CMUT. One of acoustic and electrical signals is generated with variation between a first electrode on a membrane and a second electrode. A voltage between the electrodes is limited with a protection circuit.

In a third aspect, a system is provided for preventing damage to a CMUT. A high voltage protection circuit connects with the CMUT.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a cross-section diagram of one embodiment of a portion of a CMUT;

FIG. 2 is a circuit diagram of a transmit and receive circuit using a CMUT with voltage protection;

FIG. 3 is a circuit diagram of one embodiment of a high voltage protection circuit;

FIG. 4 is a circuit diagram of an alternative high voltage protection circuit; and

FIG. 5 is a flow chart diagram of one embodiment of a method for protecting a CMUT.

### DETAILED DESCRIPTION OF THE DRAWINGS AND PRESENTLY PREFERRED EMBODIMENTS

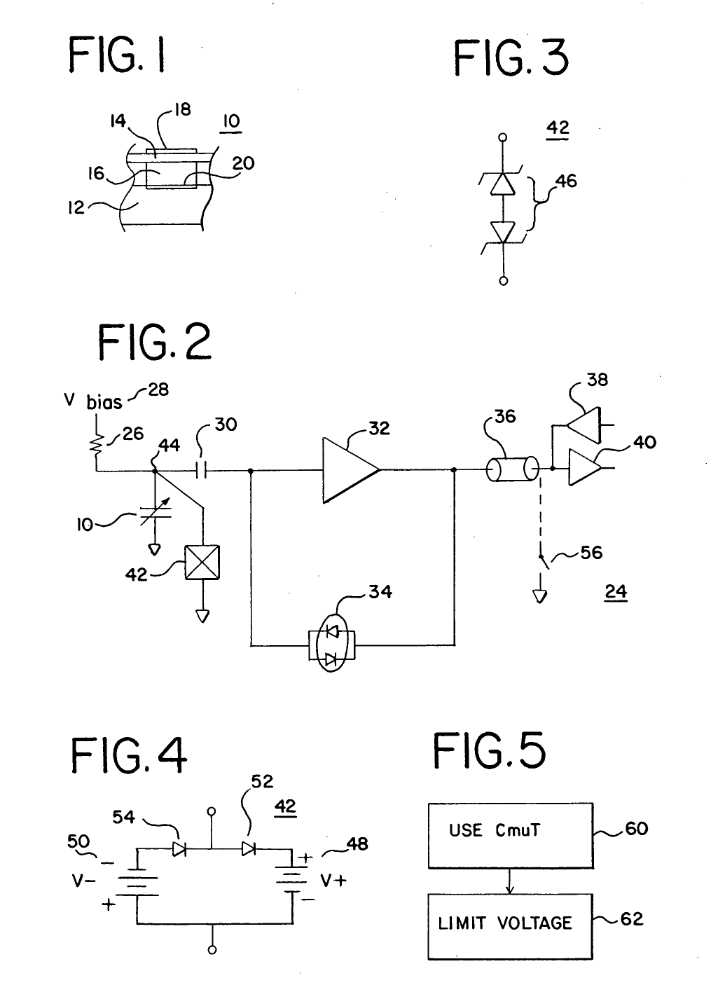

FIG. 1 shows one embodiment of a cross-sectional portion of a CMUT element 10. The CMUT element 10 includes a substrate 12, a flexible membrane 14, a void 16, an electrode 18 adjacent to the membrane 14 and an electrode 20 within the void 16. Additional, different or fewer components may be provided. For example, the electrode 18 on the membrane 14 is positioned within the void 16 or on a bottom surface of the membrane 14. While shown as a single membrane 14 and void 16, a plurality of such membranes 14 and voids 16 are provided for any given element. Tens, hundreds or even thousands of membranes 14 and associated voids 16 may be provided for a given transducer array of elements. The CMUT element 10 is manufactured using complimentary metal-oxide semiconductor processes in one embodiment, but other now known or later developed processes for forming microelectromechanical structures may be used.

CMUTs typically have high electrical impedance. To receive electrical signals through a transducer cable to an ultrasound imaging system, a preamplifier is provided within the transducer probe. Since the same signal line is used for transmission as well as reception, large transmitted signals are routed around the preamplifier for generating acoustic energy. Parasitic capacitance shunting each CMUT element 10 is similar to or smaller than the capacitance of the element 10. CMUT elements 10 typically have 3-4 pF capacitance. Circuitry associated with the CMUT element 10, such as high voltage protection circuitry, is adapted to introduce similar or lesser capacitance. Alternatively, a greater capacitance is introduced.

FIG. 2 shows one embodiment of a system 24 for preventing damage to a CMUT element 10. The system 24 includes one or more membranes and associated voids as an element 10 connected through a resistor 26 to a DC bias source 28. The CMUT element 10 also connects through a coupling capacitor 30 to a receive preamplifier 32 and transmit path diodes 34. The preamplifier 32 and transmit path diodes 34 connect through a cable 36 to a transmitter 38 and a receiver 40 of the imaging system. A high voltage protection circuit 42 also connects with the CMUT element 10. Other circuit configurations with different, additional or fewer components may be provided, such as providing the transmit and receive path through the cable 36 without the preamplifier 32.

In one embodiment, the system 24 without the high voltage protection circuit 42 is disclosed in U.S. Pat. No. 6,269,052, the disclosure of which is incorporated herein by reference. For receive operation, the CMUT element 10 generates electrical signals, such as on the electrode 18 while holding the electrode 20 at a ground potential or vice versa. The electrical signals pass through the coupling capacitor 30 to the preamplifier 32. Received signals typically have voltages below the 0.7 pass voltage of the diodes 34. As a result, the diodes 34 act as an open circuit. The preamplifier 32 is any of various now known or later developed preamplifiers, such as a preamplifier disclosed in U.S. Pat. No. 6,269,052. The receive signals are then amplified and communicated through the cable 36 to the receiver 40 for beamforming. In one embodiment, the preamplifier 32 is integrated on a same substrate as the CMUT element 10, but may be integrated on a different substrate in other embodiments. The cable 36 separates the transducer probe from the imaging system.

The transmitter 38 is a unipolar, bipolar or sinusoidal transmitter for generating high voltage electrical signals. The signals pass through the cable 36, such as a coaxial cable, from the imaging system to the transducer probe. Transistors or other circuitry of the preamplifier 32 prevent passage of the high voltage into the preamplifier 32. Since the transmit waveform has voltages well exceeding the breakdown voltage across the diodes 34, the diodes 34 pass the transmit voltage waveform through the coupling capacitor 32 to the transducer element 10. For example, the transmit waveforms are provided to the electrode 18 adjacent to the membrane while the other electrode 20 is held connected to a ground or vice versa. The transmit waveform is an oscillating or varying waveform. The transmit waveform varies around a DC voltage level established by the voltage bias circuit 28. The voltage bias circuit 28 is a DC voltage source for biasing the membrane 14 of the CMUT element 10. For example, the bias voltage is around 100 volts. The transmit waveform provides a 200-300 volt swing, depending on the breakdown voltage of the transducer element 10. The voltage swing of the transmit waveform is as high as possible without exceeding safety or government regulation limits, such as the mechanical index associated with acoustic energy. In one embodiment, the breakdown voltage of the transducer element 10 is 150-300 volts, such as 230-250 volts or about 240 volts. Different breakdown voltages may be provided based on different CMUT structures. The transmit waveform is generally designed to avoid exceeding the breakdown voltage.

The high voltage protection circuit 42 connects with a conductor 44 connected with the membrane 14. The conductor 44 is a metal signal trace, the electrode 18, the electrode 20, doped silicon, or other now known or later developed conductor. In one embodiment, the high voltage protection circuit 42 connects directly with a signal trace associated with the electrode 18 or 20. Alternatively, the high voltage protection circuit 42 connects with the signal trace between the coupling capacitor 30 and the transmitter 38 or receiver 40. The high voltage protection circuit is connected with the conductor and associated CMUT element 10 either directly or indirectly. Direct connection may minimize risk from breakdown voltages by applying the high voltage protection immediately at the CMUT element 10.

In one embodiment, the protection circuit 42 connects on the conductor between the output of the preamplifier 32 and the connector to the imaging system. The parasitic capacitance of the protection circuit 42 may not load the CMUT 10, but is buffered by the preamplifier 32. A separate protection circuit 42 may be used on the one or more bias lines as any bias lines are decoupled from the protection circuit 42 placed on the other side of preamplifier 32. In this embodiment, the protection limit is more or less the sum of the low frequency limiting value on the bias circuit 28 and the high frequency limiting value of the circuit placed in the location of 56 (i.e., in the system connector). The general principal is that a single protection circuit 42 can be placed at location 44 as shown for each element or placed at every non-grounded pin at the system connector or other location along the channel.

An array of electro static discharge suppressors or transient voltage suppressors may be used as the protection circuit 42 at the connector pins of the imaging system (e.g., at a same location as shown for the switch 56). Any now known or later developed electro static discharge or transient voltage suppressors may be used, such as electroceramic (e.g., multilayer varistor), silicon (e.g., avalanche diodes or SCR/Diode cells), thyristors, Schottky diodes, Zener diodes or polymer voltage material (e.g., polymer filed gap) based circuits. Other circuits operable to clamp or limit the voltage may be used. In one embodiment, the protection circuit 42 is packages as an integrated circuit or array (e.g., 16 or other number of Schottky or Zener diodes).

The high voltage protection circuit 42 is a voltage limiting circuit connected with the CMUT element 10 through the conductor 44. Any now known or later developed voltage limiting circuit may be used. The high voltage protection circuit 42 allows transmit and receive operation while limiting a maximum voltage applied to the CMUT element 10.

FIG. 3 shows one embodiment of a voltage limiting circuit 42. The voltage limiting circuit 42 includes at least one Zener diode 46 connected between the conductor 44 and a ground. For example, two Zener diodes 46 are connected in series with opposite polarities between the conductor 44 and ground. For unipolar operation, a single Zener diode 46 may limit the positive or negative unipolar pulses. For bipolar operation, two Zener diodes 46 as shown in FIG. 3 are provided, one Zener diode 46 for limiting positive voltages and the other Zener diode 46 for limiting negative voltages. In one embodiment, no additional components are connected between the conductor 44 and ground through the voltage limiting circuit 42. Alternatively, one or more intervening components are provided. A plurality of Zener diodes may be used in series to further set the limiting positive or negative voltage. The Zener diode 46 operates in a reverse mode in one embodiment.

If a reverse voltage exceeds a breakdown voltage of the Zener diode 46, the current is increased through the Zener diode 46. The Zener diode acts as a switch to keep the voltage constant or at the breakdown voltage of the Zener diode. If the voltage of the conductor 44 exceeds the breakdown voltage of the Zener diode 46, the voltage is limited or substantially maintained at a same value until the source of the voltage drops below the Zener diode breakdown voltage. The two Zener diodes 46 may have the same or different breakdown voltages. For example, the bias voltage applied to the CMUT element 10 may result in greater positive or greater negative voltages than vice versa. Zener diodes 46 with appropriate breakdown voltages are selected for limiting the voltage at the conductor 44 based on the bias voltage and the breakdown voltage of the CMUT element 10. In one embodiment, the Zener diodes have a 70 volt breakdown voltage. Alternatively, a greater or lesser breakdown voltage is used, or several Zener diodes can be connected in series to increase the effective breakdown voltage. For example, the breakdown voltage of the Zener diodes 46 is selected such that a voltage as close as possible to the breakdown voltage of the CMUT element 10 is provided. For example, the difference between the breakdown voltage of the Zener diode and the breakdown voltage of the CMUT element 10 is 5%, 1% or other percentage of the breakdown voltage of the CMUT element 10.

FIG. 4 shows another embodiment of the voltage limiting circuit 42. The voltage limiting circuit 42 includes two voltage sources 48 and 50 and two diodes 52 and 54. Each of the diodes 52 and 54 is a silicon or other now known or later developed diode, such as a Zener diode. The diodes 52 and 54 may have a minimal capacitance, such as two to three pico farads per pair of diodes. Discrete diode components may be provided in small packages, such as integrated circuit chips with a small area providing multiple diodes. A small size may allow for more convenient integration within a transducer probe. Diodes with selectable breakdown voltages, such as greater or lesser than 0.7 volts, may be provided. Each of the diodes 52, 54 connects between the conductor 44 and the respective voltage sources 48, 50.

One of the voltage sources 48 is a positive DC voltage source, and the other voltage source 50 is a negative DC voltage source. The voltage sources 48 and 50 are provided within the transducer probe or provided through one or more cables from the imaging system. Any now known or later developed voltage sources may be provided. In one embodiment, one or both of the voltage sources 48 and 50 are adjustable to provide a different DC voltage source for providing adjustable voltage limits. When a positive high voltage on the conductor 44 exceeds the positive high voltage of the voltage source 48, current then flows through the diode 52 to the voltage source 48. The diode 52 acts as a switch to drain current and limit the voltage on the conductor 44. The diode 54 and negative voltage source 50 act to limit the negative voltage.

Two example embodiments of voltage limiting circuits 42 are described above. Other voltage limiting circuits that are now known or later developed may be used in alternative embodiments. For example, FIG. 2 shows another possible voltage limiting circuit connected with the cable 36. A switch 56 is shown connected in phantom to the transmit and receive line within the imaging systems, such as at the transducer connector. In alternative embodiments, the switch 56 is positioned to connect directly to the conductor 44 or another position within the transducer probe. The switch 56 is a relay in one embodiment, such as a magnetic or microelectromechanical (e.g. solid state) relay. The switch 56 is operable to short the electrodes 18, 20 of the CMUT element 10 together. For example, one of the electrodes 20 is connected with ground potential. The switch 56 connects the other of the electrodes 18 to the same ground potential. By shorting the electrodes together, the voltage for both of the CMUT elements 18, 20 is limited. The switch 56 is closed when the transducer is not in use, such as to protect from electrostatic charges during manufacture or handling.

The same or different voltage protection circuit 42 connects with each of the CMUT elements 10 within an array. For example, different diodes 52 and 54 shown in FIG. 4 are provided for each of the transmit and receive paths of each element 10, but a same positive and negative voltage source is provided in common to all or a subset of the elements. As another example, the same Zener diodes 46 shown in FIG. 3 connect to all of the elements. In other embodiments, separate voltage limiting circuits 42 of the Zener diodes 46 are provided for each element 10 or for subsets of elements 10.

The voltage limiting circuit 42 is positioned within the transducer probe in one embodiment. For example, at least a portion of the voltage limiting circuit, such as one or more components, is provided within the transducer probe. As another example, the entire voltage limiting circuit is provided within the transducer probe. For further ease of manufacture or other purposes, one or more components are integrated with the preamplifier 32. For example, the silicon diodes 52 and 54 are integrated onto a same silicon substrate or integrated circuit as the preamplifier 32. For example, the switch 56 is integrated with the preamplifier 32 within the transducer probe or with the CMUT element 10 also within the transducer probe. By positioning within the transducer probe, the voltage limiting circuit 42 may connect between the CMUT element 10 and the preamplifier 32. In another embodiment, at least one component of the voltage limiting circuit 42 is integrated onto a same substrate as the CMUT element 10. For positioning within the transducer probe, the voltage limiting circuit 42 connects to the CMUT element 10 between the electrode 18, 20 and the cable 36.

Alternatively, all or a portion of the voltage limiting circuit 42 is positioned within an imaging system, such as part of the transducer connector. For example, the switch 56, the Zener diodes 46 or the circuit shown in FIG. 4 are provided within the transducer connector of an imaging system.

FIG. 3 shows a flow chart of one method for preventing damage to a CMUT. Additional, different or fewer acts may be provided in a same or different order.

In act 60, the CMUT is used for transducing between acoustic and electric energies. One of acoustic or electrical signals is generated with variation between an electrode on a membrane and another electrode. For example, acoustic energy is generated by applying at varying electrical signal to an electrode at the bottom of a void while holding the electrode adjacent to a membrane at a ground potential or vice versa. In response to the varying electrical signal potential between the electrodes, the membrane flexes. The flexing of the membrane generates acoustical energy. As another example, acoustical energy causes the membrane to flex. One electrode is held at a constant potential, such as a ground or bias potential. Electrical signals are generated on the other electrode in response to the acoustic variance associated with the membranes relative position.

In act 62, the voltage between the electrodes of the CMUT is limited with a protection circuit either during the use of act 60 or when the CMUT is not used. The voltage difference between the electrodes of the CMUT is held substantially constant where the voltage may exceed a breakdown voltage of the membrane. “Substantially constant” is used herein to account for component tolerances, ringing, temperature variations or differences in current drain given an amount of excess being attempted by a transmitter or electrostatic charge. Where the voltage difference is below the breakdown voltage and protection voltage, the voltage signal is allowed to vary. Where the voltage would otherwise exceed the breakdown voltage or a voltage near the breakdown voltage (i.e., the protection voltage limit), the voltage difference is held constant for the duration of any potential excess. To hold the voltage constant, current is drained away from one of the electrodes. Draining current acts to limit the voltage difference between the electrodes. The voltage limits are set based on the breakdown voltage of the CMUT rather than or in addition to limits set based on patient protection. The breakdown voltage of the CMUT may be greater than a voltage limit imposed by the same or different circuit for patient protection.

The voltage is limited with any various protection circuits. For example, at least one Zener diode connected between an electrode of the element and ground limits the voltage. As another example, a diode connected between a voltage source and an electrode of the CMUT element limits the voltage of the electrode. One or more components may be connected between the electrode and the protection circuit while still limiting the voltage at the electrode. As yet another example, the electrodes are shorted together while not being used.

For use with the CMUT, the protection circuit is positioned within the transducer probe. For example, the protection circuit connects the conductor between the CMUT and preamplifier. In one embodiment, the protection circuit is integrated in a same substrate with the receiver preamplifier. In alternative embodiments, the protection circuit is provided within the transducer probe between the preamplifier 32 and the imaging system. In yet other embodiments, the protection circuit is provided within the imaging system.

An alternative technique for providing protection is to use a relay or switch which would short the two electrodes on the CMUT device when the device is not in use or when it is separated from the system by the operator. This way the device would have protection against electro static discharge. The relays or switches can be placed at the probe connector or the transducer handle. This can also provide protection for the embedded electronics within the transducer.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A system for preventing damage to a capacitive membrane ultrasound transducer, the system comprising:
a membrane;
a conductor connected with the membrane; and
a voltage limiting circuit connected with the conductor.

2. The system of claim 1 wherein the membrane comprises a flexible membrane adjacent a void and the conductor comprises an electrode on the flexible membrane and a signal trace connected with the electrode.

3. The system of claim 1 wherein the voltage limiting circuit comprises at least one Zener diode connected between the conductor and a ground.

4. The system of claim 3 wherein the at least one Zener diode comprises two Zener diodes in series with opposite polarities.

5. The system of claim 1 wherein the voltage limiting circuit comprises:
a first voltage source; and
a first diode connected between the conductor and the first voltage source.

6. The system of claim 5 wherein the voltage limiting circuit further comprises:
a second voltage source with a negative voltage, the first voltage source having a positive voltage;
a second diode connected between the conductor and the second voltage source.

7. The system of claim 1 further comprising:
first and second electrodes associated with the membrane;
wherein the voltage limiting circuit comprises a switch operable to short the first electrode to the second electrode.

8. The system of claim 7 wherein the switch comprises a relay.

9. The system of claim 1 wherein at least one component of the voltage limiting circuit is within a transducer probe.

10. The system of claim 9 wherein the at least one component is integrated with a preamplifier.

11. The system of claim 1 wherein at least one component of the voltage limiting circuit is within a transducer connector of an imaging system.

12. A method for preventing damage to a capacitive membrane ultrasound transducer, the method comprising:
(a) generating one of acoustic and electrical signals with variation between a first electrode on a membrane and a second electrode; and
(b) limiting a voltage between the first and second electrodes with a protection circuit.

13. The method of claim 12 wherein (b) comprises holding a voltage between the first and second electrodes substantially constant where the voltage may exceed a breakdown voltage of the membrane.

14. The method of claim 12 wherein (b) comprises draining current away from at least one of the first and second electrodes, wherein the drain in current limits a voltage difference between the first and second electrodes.

15. The method of claim 12 wherein (b) comprises limiting the voltage with at least one Zener diode connected between one of the first and second electrodes and a ground.

16. The method of claim 12 wherein (b) comprises limiting the voltage with a first voltage source and a first diode connected between one of the first and second electrodes and the first voltage source.

17. The method of claim 12 wherein (b) comprises shorting the first electrode to the second electrode at time other than during performance of (a).

18. The method of claim 12 wherein the protection circuit is within a transducer probe.

19. The method of claim 18 wherein (b) comprises limiting with the protection circuit integrated with a receive preamplifier.

20. A system for preventing damage to a capacitive membrane ultrasound transducer, the system comprising:
the capacitive membrane ultrasound transducer; and
a high voltage protection circuit connected with the capacitive membrane ultrasound transducer.

21. The system of claim 21 wherein the high voltage protection circuit connects between the capacitive membrane ultrasound transducer and a preamplifier within a transducer probe.
